(19) United States
(12) Patent Application Publication
(10) Pub. No.: US 2009/0290052 A1
(43) Pub. Date: Nov. 26, 2009

(54) Color Pixel Pattern Scheme for High Dynamic Range Optical Sensor

(75) Inventors: Li Liu, Cortland, NY (US); Jeffrey Jon Zarnowski, McGraw, NY (US); Ketan Vrajlal Karia, Cortland, NY (US); Thomas Poonnen, Cortland, NY (US); Michael Eugene Joyner, McGraw, NY (US)

Correspondence Address: MORRISON & FOERSTER, LLP, 555 WEST FIFTH STREET, SUITE 3500, LOS ANGELES, CA, 90013-1024, US

(73) Assignee: Panavision Imaging, LLC

(21) Appl. No.: 12/126,347

(22) Filed: May 23, 2008

(51) Int. Cl. H04N 9/04

(52) U.S. Cl. 348/277; 348/E09.002

(57) ABSTRACT

The use of a Bayer pattern array in digital image sensors to enhance the dynamic range of the sensors is disclosed. Each Bayer pattern in the array can include three different pixels having a first exposure, and a fourth pixel (which is the same color as one of the other pixels in the array) having a second exposure. The dynamic range of the Bayer pattern array can be enhanced by using different exposure times for the pixels. Each pixel can capture only one channel (i.e. either red (R), green (G) or blue (B) light). Interpolation of neighboring pixels, including those having different exposure times, can enable the pixels in the Bayer pattern array to generate missing color information and effectively become a color pixel, and can allow the Bayer pattern array to have a higher dynamic range.

### FIELD OF THE INVENTION

Embodiments of the invention relate to digital color image sensors, and more particularly, to an enhanced dynamic range sensor that utilizes a Bayer pattern color array having pixels with different exposure times to generate the data for color pixels in an image.

### BACKGROUND OF THE INVENTION

Digital image capture devices are becoming ubiquitous in today's society. High-definition video cameras for the motion picture industry, image scanners, professional still photography cameras, consumer-level “point-and-shoot” cameras and hand-held personal devices such as mobile telephones are just a few examples of modern devices that commonly utilize digital color image sensors to capture images. Regardless of the image capture device, in most instances the most desirable images are produced when the sensors in those devices can capture fine details in both the bright and dark areas of a scene or image to be captured. In other words, the quality of the captured image is often a function of the amount of detail at various light levels that can be captured. For example, a sensor capable of generating an image with fine detail in both the bright and dark areas of the scene is generally considered superior to a sensor that captures fine detail in either bright or dark areas, but not both simultaneously.

Thus, higher dynamic range becomes an important concern for digital imaging performance. For sensors with a linear response, their dynamic range can be defined as the ratio of their output's saturation level to the noise floor at dark. This definition is not suitable for sensors without a linear response. For all image sensors with or without linear response, the dynamic range can be measured by the ratio of the maximum detectable light level to the minimum detectable light level. Prior dynamic range extension methods fall into two general categories: improvement of sensor structure, a revision of the capturing procedure, or a combination of the two.

Structure approaches can be implemented at the pixel level or at the sensor array level. For example, U.S. Pat. No. 7,259,412 introduces a HDR transistor in a pixel cell. A revised sensor array with additional high voltage supply and voltage level shifter circuits is proposed in U.S. Pat. No. 6,861,635. The typical method for the second category is to use different exposures over multiple frames (e.g. long and short exposures in two different frames to capture both dark and bright areas of the image), and then combine the results from the two frames. The details are described in U.S. Pat. No. 7,133,069 and U.S. Pat. No. 7,190,402. In U.S. Pat. No. 7,202,463 and U.S. Pat. No. 6,018,365, different approaches with combination of two categories are introduced.

### SUMMARY OF THE INVENTION

Embodiments of the invention are directed to the use of a Bayer pattern array in digital image sensors to enhance the dynamic range of the sensors. In some embodiments, each Bayer pattern in the array can include three different pixels having a first exposure, and a fourth pixel (which is the same color as one of the other pixels in the array) having a second exposure. The dynamic range of the Bayer pattern array can be enhanced by using different exposure times for the pixels. Each pixel can capture only one channel (i.e. either red (R), green (G) or blue (B) light). Interpolation of neighboring pixels, including those having different exposure times, can enable the pixels in the Bayer pattern array to generate missing color information and effectively become a color pixel, and can allow the Bayer pattern array to have a higher dynamic range. The Bayer pattern arrays can be suitable for consumer electronics imagers such as those found in mobile telephone cameras, where the available pixel space is limited.

One exemplary Bayer pattern array can be formed as a 4×4 array of individual pixels from a repeating 2×2 pattern, which is similar to a conventional 2×2 Bayer pattern, except that each pattern contains two green pixels “G—long exposure” (G_{L}) and “G—short exposure” (G_{S}) arranged in a diagonal orientation, and a R and B pixel in the opposite diagonal orientation.

The G_{L} pixel can have a longer exposure time relative to the G_{S} pixel and can be more capable of capturing the dark areas of a scene (greater sensitivity to light), while the G_{S} pixel can be more capable of capturing the bright areas of a scene. Thus, the pattern has a structure similar to a conventional Bayer pattern, but different timing logic. The color green can be chosen as the repeating color in each pattern because green is generally more sensitive to the human eye than other colors. With G_{L} and G_{S} present in every pattern, there can be twice the number of G pixels as R and B pixels to provide low-light details.

The R and B pixels in each pattern each can have the same exposure time, either long or short, depending on the view to be captured. For example, for exterior views, short exposure times equal to the exposure for G_{S} can be used for the R and B pixels, whereas for interior views, long exposures equal to the exposure for G_{L} can be used. In this arrangement, when the R and B pixels are set to a long exposure time along with the G_{L} pixel, the pattern can provide intensity and color information for a dark scene. However, because the long exposure pixels can become saturated in a bright scene, only limited information can be captured in a bright scene. Thus, the bright regions can be somewhat monochromatic. Similarly, when the R and B pixels are set to a short exposure time along with the G_{S} pixel, the pattern can provide intensity and color information for a bright scene, but only limited information for a dark scene.

In a practical example, as the camera is moved into an interior area, the R and B pixels can be automatically or manually switched to match the exposure time of G_{L}, such that pixels G_{L}, R and B are set to a longer exposure to capture darker images, while the G_{S} pixel is set to a shorter exposure time to capture bright images. In general, therefore, within each pattern there can always be three pixels with the same exposure time, and one pixel with a different exposure time.

As described above, each of the pixels in the exemplary Bayer pattern array are used to provide color pixel output information (information for all three colors, R, G and B). Because each pixel only receives a single color, the Bayer pattern array is a sub-sampled pattern, and the missing information for the other two colors can be obtained by interpolating adjacent pixel information.

To interpolate the adjacent pixels, it can be beneficial to use existing Bayer pattern interpolation methods without modification to the extent possible. However, before these existing interpolation methods can be used, the pixels in the Bayer pattern arrays can be combined using a weighted average method. The effect of combining pixels of different exposure times is that the overall dynamic range for the array can be increased.

To combine pixels according to the weighted average method, the averaging of nearby G pixels and R pixels is performed to obtain combined G and R pixels. First, one or more row readouts are performed to read out the pixel data from one or more rows, and this raw pixel data is stored in memory. Next, pixels from the raw array can be averaged to compute each pixel in a combined array, which is again stored in memory.

After this combining step is completed for all pixels and the combined array is stored, the combined array is now in the form of repeating conventional Bayer patterns. As the combined array is created, any existing Bayer pattern interpolation algorithm can be used (e.g. a bilinear interpolation algorithm), executed by a processor and/or a state machine, for example, to interpolate the colors from adjacent combined pixels and compute R, G and B color pixel output values for every pixel in the array.

At times, averaging like-colored nearby pixels with different exposure times may not yield an optimal image. Therefore, in another embodiment of the invention, mixture control scaling factors, or weight (e.g. 0.3 G_{S}+0.7 G_{L}) can be used instead of averaging. Exemplary scaling factors αᵢ (i=R, G, B) can be normalized to be between [0,1]. Pixels with one exposure time (e.g. a short exposure time) can be multiplied by αᵢ, while the pixels with another exposure time can be multiplied by 1−αᵢ. The result is the summation of the two. Scaling can be implemented before interpolation or during raw pixel readout.

In addition, an offset can be added to either the scaled or averaged result to change the brightness levels. The offset, or brightness control factor, can be implemented as a 3 by 1 vector. For 8-bit images, its elements can range between [−255,255]. The brightness control factor can be added to the pixel output values channel by channel to adjust the overall intensity levels (brightness) of the outputs. In addition, the factors can be changed according to the exposure level. Therefore, for a given Bayer array pattern, multiple brightness control factors can be utilized depending on the exposure level. This operation can be performed before or after Bayer pattern interpolation, during the raw pixel readout (ADC control), or during the combining step.

### BRIEF DESCRIPTION OF THE DRAWINGS

FIG. 1a illustrates an exemplary Bayer pattern array formed as a 4×4 array of individual pixels according to embodiments of the invention.

FIG. 1b is a representation of an exemplary image including a bright area (outside lighting seen through window) and a dark area (room interior) taken with a digital image sensor containing the exemplary Bayer pattern array of FIG. 1a according to embodiments of the invention.

FIG. 2a illustrates another exemplary Bayer pattern array formed as a 4×4 array of individual pixels according to embodiments of the invention.

FIG. 2b is a representation of an exemplary image including a bright area and a dark area taken with a digital image sensor containing the exemplary Bayer pattern array of FIG. 2a according to embodiments of the invention.

FIG. 2c illustrates an effect of the exemplary array of FIG. 2a on spatial resolution according to embodiments of the invention.

FIG. 3a illustrates an exemplary Bayer pattern array formed as a 4×4 array of individual pixels, and the application of an exemplary de-mosaic methodology to the array to generate a combined array according to embodiments of the invention.

FIG. 3b illustrates the exemplary averaging of G and B pixels of different exposures to generate combined pixels G_{C} and B_{C} according to embodiments of the invention.

FIG. 3c illustrates an exemplary combined array resulting from the de-mosaic methodology shown in FIGS. 3a and 3b according to embodiments of the invention.

FIG. 3d is a representation of an exemplary image captured with a digital image sensor containing the Bayer pattern array of FIG. 2a, in which nearby long and short exposure R, G and B pixels are separately averaged to compute each combined pixel in the combined array according to embodiments of the invention.

FIG. 3e is a representation of an exemplary image captured with a digital image sensor containing the Bayer pattern array of FIG. 2a, in which the long exposure R_{L}, G_{L} and B_{L} pixels are scaled by 0.3 to de-emphasize dark areas and the short exposure R_{S}, G_{S} and B_{S} pixels are scaled by 0.7 to enhance the resolution and color of the bright areas according to embodiments of the invention.

FIG. 3f is a representation of an exemplary image captured with a digital image sensor containing the Bayer pattern array of FIG. 2a, in which the long exposure R_{L}, G_{L} and B_{L} pixels are scaled by 0.7 to enhance the resolution and color of the dark areas and the short exposure R_{S}, G_{S} and B_{S} pixels are scaled by 0.3 to de-emphasize the bright areas according to embodiments of the invention.

FIG. 4 illustrates an exemplary image capture device including a sensor formed from Bayer pattern arrays according to embodiments of the invention.

FIG. 5 illustrates a hardware block diagram of an exemplary image processor that can be used with a sensor formed from multiple Bayer pattern arrays according to embodiments of the invention.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

Embodiments of the invention are directed to the use of a Bayer pattern array in digital image sensors to enhance the dynamic range of the sensors. In some embodiments, each Bayer pattern in the array can include three different pixels having a first exposure, and a fourth pixel (which is the same color as one of the other pixels in the array) having a second exposure. The dynamic range of the Bayer pattern array can be enhanced by using different exposure times for the pixels. Each pixel can capture only one channel (i.e. either red (R), green (G) or blue (B) light). Interpolation of neighboring pixels, including those having different exposure times, can enable the pixels in the Bayer pattern array to generate missing color information and effectively become a color pixel, and can allow the Bayer pattern array to have a higher dynamic range. The Bayer pattern arrays can be suitable for consumer electronics imagers such as those found in mobile telephone cameras, where the available pixel space is limited.

Although the Bayer pattern arrays according to embodiments of the invention may be described and illustrated herein primarily in terms of sensors for consumer electronics devices, it should be understood that any type of image capture device for which an enhanced dynamic range is desired can utilize the sensor embodiments described herein. Furthermore, although the Bayer pattern arrays may be described and illustrated herein in terms of 4×4 arrays of pixels formed from four 2×2 Bayer patterns, other color pattern and array sizes can be utilized as well. In addition, although the pixels in the Bayer pattern arrays may be described as R, G and B pixels, in other embodiments of the invention colors other than R, G, and B can be used, such as the complementary colors cyan, magenta, and yellow, and even different color shades (e.g. two different shades of blue) can be used.

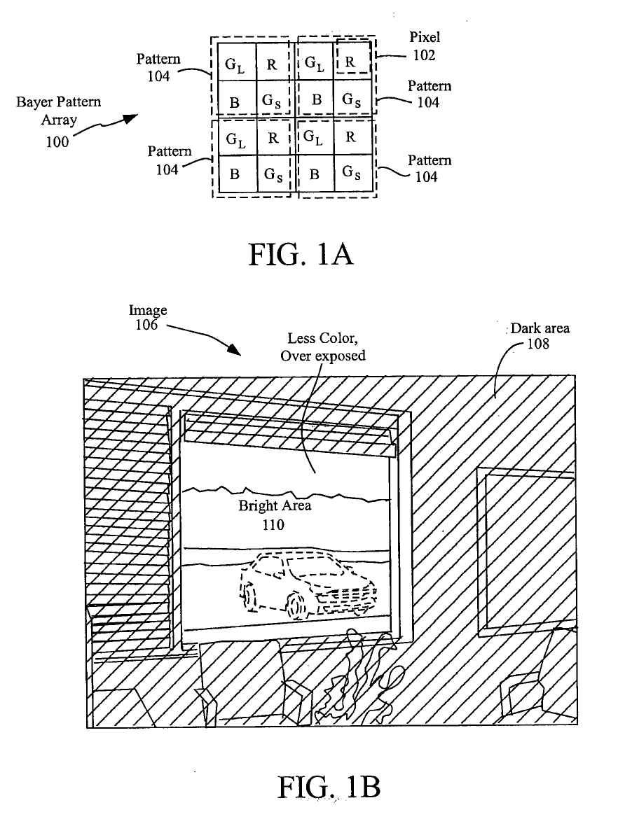

FIG. 1a illustrates an exemplary Bayer pattern array 100 formed as a 4×4 array of individual pixels 102 according to embodiments of the invention. In the example of FIG. 1a, the array 100 is formed from a repeating 2×2 pattern 104, which is similar to a conventional 2×2 Bayer pattern, except that each pattern contains two green pixels “G—long exposure” (G_{L}) and “G—short exposure” (G_{S}) arranged in a diagonal orientation, and a R and B pixel in the opposite diagonal orientation.

The G_{L} pixel can have a longer exposure time relative to the G_{S} pixel and can be more capable of capturing the dark areas of a scene (greater sensitivity to light), while the G_{S} pixel can be more capable of capturing the bright areas of a scene. Thus, pattern 104 has a structure similar to a conventional Bayer pattern, but different timing logic. The color green can be chosen as the repeating color in each pattern 104 because green is generally more sensitive to the human eye than other colors (i.e. at low light levels, the human eye can usually see more details and contrast in green images than in images of other colors). With G_{L} and G_{S} present in every pattern 104, there can be twice the number of G pixels as R and B pixels to provide low-light details.

The R and B pixels in each pattern each can have the same exposure time, either long or short, depending on the view to be captured. For example, for exterior views, short exposure times equal to the exposure for G_{S} can be used for the R and B pixels, whereas for interior views, long exposures equal to the exposure for G_{L} can be used. So, for example, for exterior views, the G_{S}, R and B pixels of a pattern can be set to a shorter exposure time to capture bright images, whereas the G_{L} pixel can be set to a longer exposure time to capture dark images. In this arrangement, when the R and B pixels are set to a long exposure time along with the G_{L} pixel, the pattern can provide intensity and color information for a dark scene. However, because the long exposure pixels can become saturated in a bright scene, only limited information can be captured in a bright scene. Thus, the bright regions can be somewhat monochromatic (i.e. shades of gray). Similarly, when the R and B pixels are set to a short exposure time along with the G_{S} pixel, the pattern can provide intensity and color information for a bright scene, but only limited information for a dark scene.

In a practical example, as the camera is moved into an interior area, the R and B pixels can be automatically or manually switched to match the exposure time of G_{L}, such that pixels G_{L}, R and B are set to a longer exposure to capture darker images, while the G_{S} pixel is set to a shorter exposure time to capture bright images. In general, therefore, within each pattern 104 there can always be three pixels with the same exposure time, and one pixel with a different exposure time.

FIG. 1b is a representation of an exemplary image 106 including a bright area (outside lighting seen through window) 110 and a dark area (room interior) 108 taken with a digital image sensor containing the Bayer pattern array of FIG. 1a. In the example of FIG. 1b, the R and B pixels have a long exposure time along with the G_{L} pixel because the sensor is within dark room 108. Because the R, B and G_{L} pixels in each pattern are overexposed in the bright area 110, minimal red and blue color information can be interpolated from adjacent pixels, and only the G_{S} pixel in each pattern is available to capture the bright areas (exterior area 110 viewed through a window). As a result, a mostly monochrome and green overexposed image appears in the bright area (overexposure indicated by image with dashed lines). Note that in the darker areas (within room 108), a more complete color spectrum is seen.

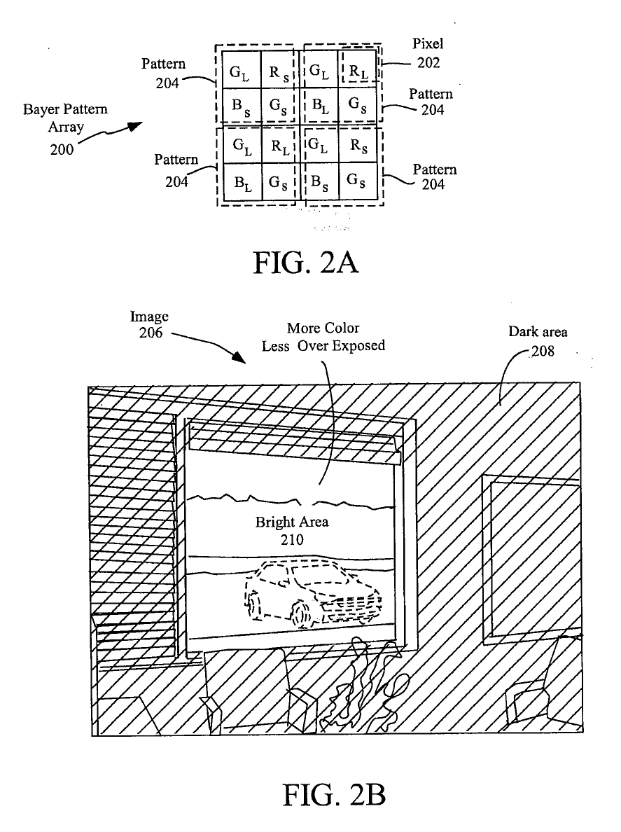

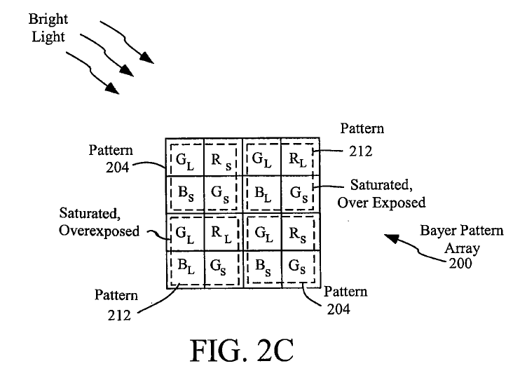

FIG. 2a illustrates an exemplary Bayer pattern array 200 formed as a 4×4 array of individual pixels 202 according to embodiments of the invention. In the example of FIG. 2a, the array 200 is formed from two repeating 2×2 patterns 204 and 212, each of which is similar to a conventional 2×2 Bayer pattern, except that each pattern contains two green pixels G_{L} and G_{S} arranged in a diagonal orientation, and either a “R—short exposure” (R_{S}) and “B—short exposure” (B_{S}) pixel pair (pattern 204) or a “R—long exposure” (R_{L}) and “B—long exposure” (B_{L}) pixel pair (pattern 212) in the opposite diagonal orientation.

The G_{L}, R_{L} and B_{L} pixels can have longer exposure times relative to the G_{S}, R_{S} and B_{S} pixels and can be more capable of capturing the dark areas of a scene (greater sensitivity to light), while the G_{S}, R_{S} and B_{S} pixels can be more capable of capturing the bright areas of a scene. Thus, patterns 204 and 212 have a structure similar to a conventional Bayer pattern, but different timing logic. In the embodiment of FIG. 2a, the R_{L}, G_{L} and B_{L} pixels of pattern 212 can provide intensity and color information for a dark scene, while the R_{S}, G_{S} and B_{S} pixels of pattern 204 can provide intensity and color information for a bright scene.

As described above, the single repeating pattern in the previous embodiment (the exemplary Bayer pattern array of FIG. 1a) will have either three short exposure pixels and one long exposure pixel, or three long exposure pixels and one short exposure pixel. As a result, bright scenes captured using three long exposure pixels and one short exposure pixel will be overexposed with very little color information, while dark scenes captured using three short exposure pixels and one long exposure pixel will be underexposed with very little color information. The alternative embodiment of FIG. 2a overcomes this shortcoming, because over the entire array 200, there are an equal number of pixels at a short exposure and at a long exposure. Thus, color information is not lost at a particular brightness level due to the prevalence of pixels of one exposure over another.

FIG. 2b is a representation of an exemplary image 206 including bright area (outside lighting seen through window) 210 and dark area (room interior) 208 taken with a digital image sensor containing the Bayer pattern array of FIG. 2a according to embodiments of the invention. Because half of the pixels are at a long exposure time, and half of the pixels are at a short exposure time, more contrast and a more complete color spectrum is seen in both the bright and dark areas 210 and 208, with less overexposure in the bright areas 210 (as compared to FIG. 1b).

FIG. 2c illustrates an exemplary effect of the embodiment of FIG. 2a according to embodiments of the invention. The example of FIG. 2c illustrates the effect of a bright scene on the Bayer pattern array 200 of FIG. 2a. Because the bright scene will cause pattern 212 to become saturated in both the upper right and lower left quadrants, contrast and color information is largely lost in those areas, and the only pattern providing color and contrast information is pattern 204 in the upper left and lower right quadrants. Thus, effectively only every other pattern provides color and contrast information, and as a result spatial resolution is reduced. Similarly, although not shown in FIG. 2c, for dark scenes the upper left and lower right patterns 204 will be underexposed, and only patterns 212 in the upper right and lower left quadrants will provide color and contrast information.

As described above, each of the pixels in the Bayer pattern arrays of FIGS. 1a and 2a are used to provide color pixel output information (information for all three colors, R, G and B). Because each pixel only receives a single color, the Bayer pattern array is a sub-sampled pattern, and the missing information for the other two colors can be obtained by interpolating adjacent pixel information.

To interpolate the adjacent pixels, it can be beneficial to use existing Bayer pattern interpolation methods without modification to the extent possible. However, before these existing interpolation methods can be used, the pixels in the Bayer pattern arrays can be combined using a weighted average method. The effect of combining pixels of different exposure times is that the overall dynamic range for the array can be increased.

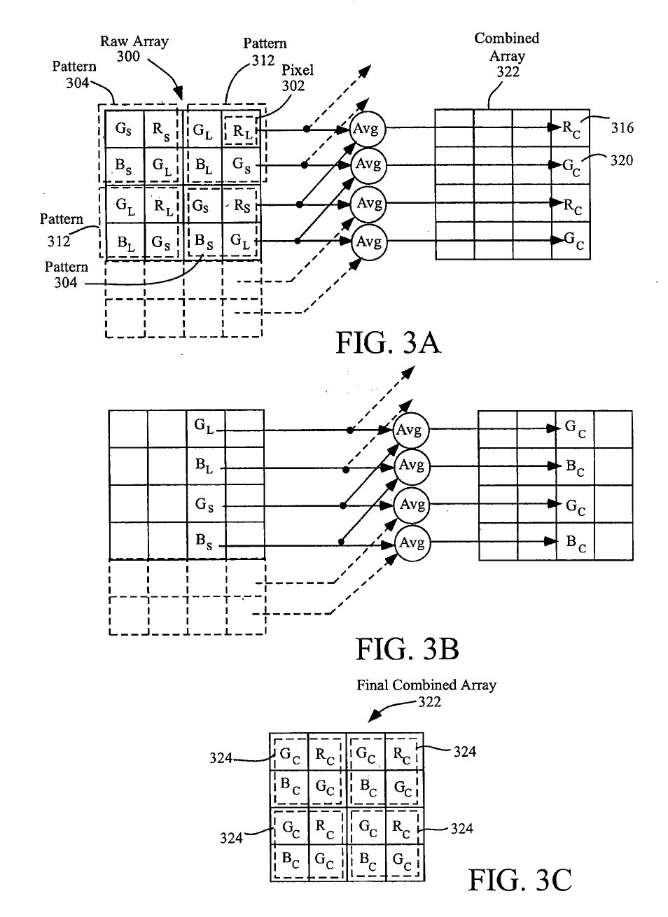

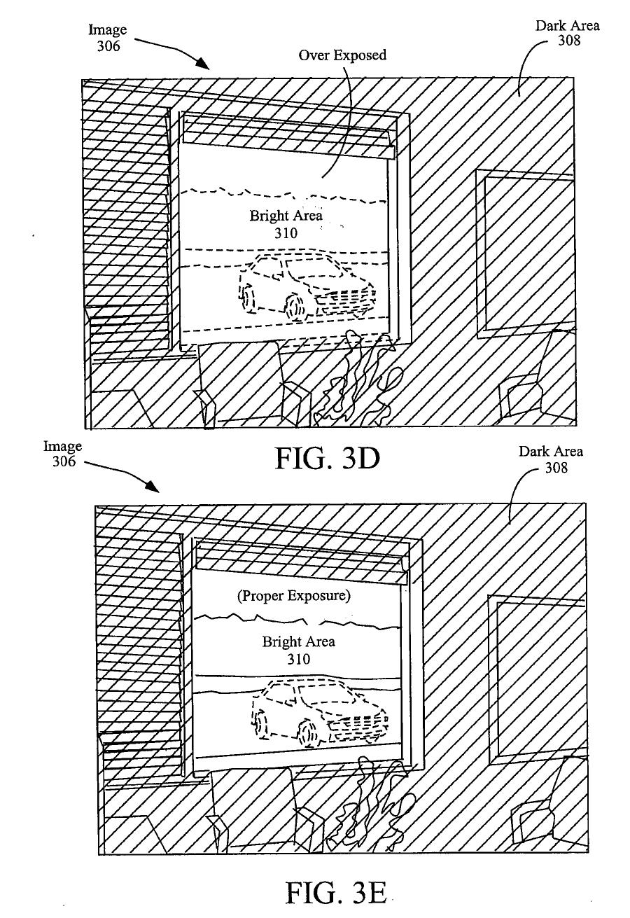

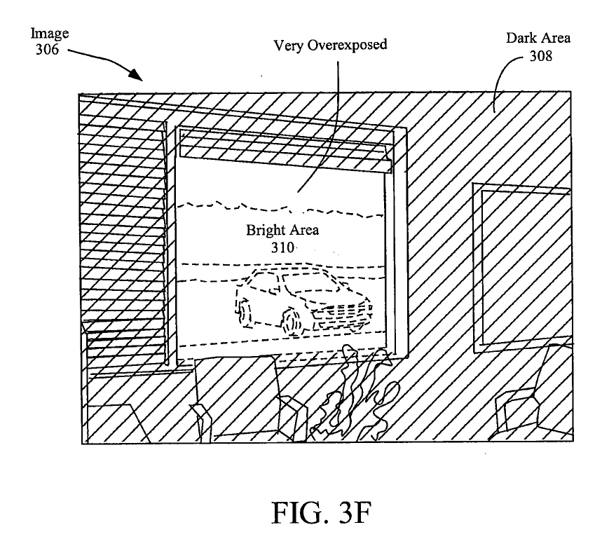

FIG. 3a illustrates an exemplary Bayer pattern array 300 formed from a 4×4 array of individual pixels 302, and the application of an exemplary weighted average method to the array according to embodiments of the invention. In the example of FIG. 3a, the array 300 is formed from two repeating 2×2 patterns 304 and 312. Note that the array 300 is similar to the array shown in FIG. 2a, except that pattern 304 has the location of the G_{S} and G_{L} pixels reversed. However, it should be understood that any Bayer pattern array according to embodiments of the invention, including those shown in FIGS. 1a and 2a, can be used.

In FIG. 3a, the averaging of nearby G pixels and R pixels is performed to obtain combined G and R pixels. First, one or more row readouts are performed to read out the pixel data from one or more rows, and this raw pixel data is stored in memory. Next, as shown in FIG. 3a, pixels from the raw array can be averaged to compute each pixel in a combined array, which is again stored in memory. At left is the raw array of pixels 300, and at right is the combined array 322. For example, R_{L} and Rₛ are averaged at 314 to generate combined R pixel R_{C} at 316. Similarly, G_{S} and G_{L} are averaged at 318 to generate combined G pixel G_{C} at 320.

FIG. 3b illustrates the averaging of G and B pixels to generate combined pixels G_{C} and B_{C} according to embodiments of the invention. This averaging step can be performed for all nearby pixels of the same color that have opposite (i.e. short and long) exposures. It should be noted that although the example of FIGS. 3a and 3b show the averaging of nearby pixels being performed in a single row (oriented vertically in the example of FIGS. 3a and 3b), the averaging step can be performed on nearby pixels in different rows, depending on the pattern designs.

FIG. 3c illustrates the result of the weighted average methodology according to embodiments of the invention, when combined array 322 has been fully computed from the raw array 300.

After this combining step is completed for all pixels and the combined array 322 is stored, the combined array is now in the form of repeating conventional Bayer patterns 324. As the combined array 322 is created, any existing Bayer pattern interpolation algorithm can be used (e.g. a bilinear interpolation algorithm), executed by a processor and/or a state machine, for example, to interpolate the colors from adjacent combined pixels and compute R, G and B color pixel output values for every pixel in the array. Note that it is not necessary that all raw row data be read out and stored before combining can begin, and it is not necessary that the averaging of all pixels be completed before the interpolation algorithms can be used. Instead, pipelined processing can be utilized so that current pixels can be read out while previously read out pixels can be processed.

At times, averaging like-colored nearby pixels with different exposure times may not yield an optimal image. Therefore, in another embodiment of the invention, mixture control scaling factors, or weight (e.g. 0.3 G_{S}+0.7 G_{L}) can be used instead of averaging. Exemplary scaling factors αᵢ (i=R, G,B) can be normalized to be between [0,1]. Pixels with one exposure time (e.g. a short exposure time) can be multiplied by αᵢ, while the pixels with another exposure time can be multiplied by 1−αᵢ. The result is the summation of the two. Scaling can be implemented before interpolation or during raw pixel readout.

In addition, an offset can be added to either the scaled or averaged result to change the brightness levels. The offset, or brightness control factor, can be implemented as a 3 by 1 vector. For 8-bit images, its elements can range between [−255,255]. The brightness control factor can be added to the pixel output values channel by channel to adjust the overall intensity levels (brightness) of the outputs. In addition, the factors can be changed according to the exposure level. Therefore, for a given Bayer array pattern, multiple brightness control factors can be utilized depending on the exposure level. This operation can be performed before or after Bayer pattern interpolation, during the raw pixel readout (ADC control), or during the combining step at 314 and 318 in FIG. 3a, for example.

FIG. 3d is a representation of an image 306 including bright area (outside lighting seen through window) 310 and dark area (room interior) 308 taken with a digital image sensor containing the Bayer pattern array of FIG. 2a, and in which nearby long and short exposure R, G and B pixels are separately averaged to compute each combined pixel in the combined array according to embodiments of the invention. In the example of FIG. 3d, averaging still results in some overexposure in the bright area 310.

FIG. 3e is similar to FIG. 3d, except that the long exposure R_{L}, G_{L} and B_{L} pixels are scaled by 0.3 to de-emphasize the dark area 308, while the short exposure R_{S}, G_{S} and B_{S} pixels are scaled by 0.7 to enhance the resolution and color of the bright area. Because of this scaling, the bright area 310 has more contrast and appears less overexposed as compared to FIG. 3d.

FIG. 3f is similar to FIG. 3d, except that the long exposure R_{L}, G_{L} and B_{L} pixels are scaled by 0.7 to enhance the resolution and color of dark area 308, while the short exposure R_{S}, G_{S} and B_{S} pixels are scaled by 0.3 to de-emphasize the bright area 310. Because of this scaling, the bright area 310 is more overexposed as compared to FIG. 3d.

In other embodiments, different scaling factors could be used for different colors (e.g. scale all G pixels by 0.7), which could enhance a particular color in a particular area (e.g. the bright area), for example. These scaling factors can be set automatically by some algorithm, or could be adjusted manually. For example, if an imager detects and estimates a lot of green in a bright area, the processor could change the scaling factors for R, G and B to balance out the color ratios or set the color ratios to a user-configurable setting. For example, a user wishing to capture a sunset may set the color ratios to emphasize red.

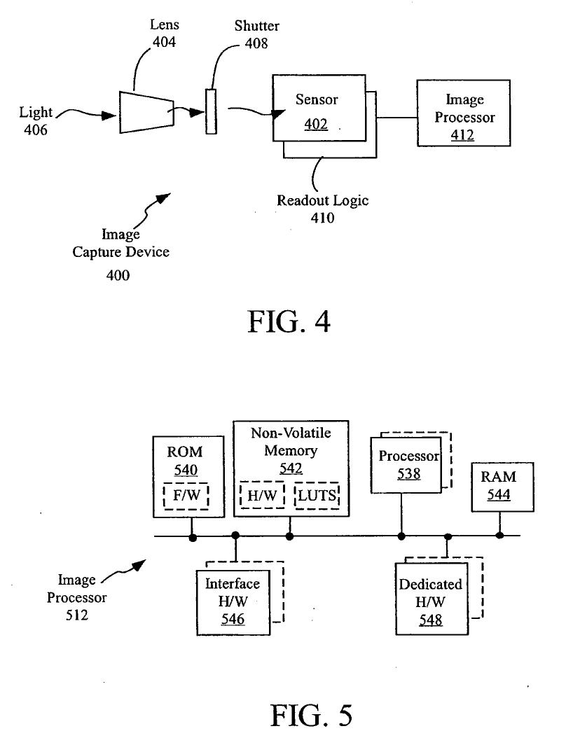

FIG. 4 illustrates an exemplary image capture device 400 including a sensor 402 formed from multiple Bayer pattern arrays according to embodiments of the invention. The image capture device 400 can include a lens 404 through which light 406 can pass. A physical/electrical shutter 408 can control the exposure of the sensor 402 to the light 406. Readout logic 410, well-understood by those skilled in the art, can be coupled to the sensor 402 for reading out pixel information and storing it within image processor 412. The image processor 412 can contain memory, a processor, and other logic for performing the combining, interpolation, and pixel exposure control operations described above.

FIG. 5 illustrates a hardware block diagram of an exemplary image processor 500 that can be used with a sensor formed from multiple Bayer pattern arrays according to embodiments of the invention. In FIG. 5, one or more processors 538 can be coupled to read-only memory 540, non-volatile read/write memory 542, and random-access memory 544, which can store boot code, BIOS, firmware, software, and any tables necessary to perform the processing described above. Optionally, one or more hardware interfaces 546 can be connected to the processor 538 and memory devices to communicate with external devices such as PCs, storage devices and the like. Furthermore, one or more dedicated hardware blocks, engines or state machines 548 can also be connected to the processor 538 and memory devices to perform specific processing operations.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A Bayer pattern array for generating color pixel output information as a component of an enhanced dynamic range image, comprising:
a plurality of patterns arranged in an array;
wherein each pattern includes a pixel of a first color, a short exposure pixel of a second color and a long exposure pixel of the second color, and a pixel of a third color.

2. The Bayer pattern array of claim 1, wherein the pixel of the first color is a red (R) pixel, the short exposure pixel of the second color is a short exposure green (G_{S}) pixel, the long exposure pixel of the second color is a long exposure green (G_{L}) pixel, and the pixel of the third color is a blue (B) pixel.

3. The Bayer pattern array of claim 1, wherein the pixels in each pattern are arranged for Bayer pattern interpolation to generate color pixel information for each pixel in the pattern.

4. The Bayer pattern array of claim 1, wherein for each pattern, the pixel of the first color and the pixel of the third color have a same exposure as either the short exposure pixel or the long exposure pixel of the second color.

5. The Bayer pattern array of claim 1, wherein about half of the patterns in the array have the pixel of the first color and the pixel of the third color with a same exposure as the short exposure pixel of the second color, and about half of the patterns in the array have the pixel of the first color and the pixel of the third color with the same exposure as the long exposure pixel of the second color.

6. The Bayer pattern array of claim 1, wherein each of the pixels in the array are coupled for being combined with nearby pixels of a same color for enhancing the dynamic range.

7. The Bayer pattern array of claim 1, wherein each of the pixels in the array are coupled for being averaged with nearby pixels of a same color for enhancing the dynamic range.

8. The Bayer pattern array of claim 1, wherein each of the pixels in the array are coupled for being combined with nearby pixels of a same color using mixture control scaling factors for enhancing the dynamic range.

9. The Bayer pattern array of claim 1, wherein each of the pixels in the array are coupled for being combined with nearby pixels of a same color using brightness control factors for enhancing brightness.

10. The Bayer pattern array of claim 1, the array integrally formed as part of an image sensor.

11. The Bayer pattern array of claim 10, the image sensor forming a part of an image capture device.

12. An image sensor for generating a plurality of color pixel outputs as components of an enhanced dynamic range image, comprising:
a plurality of Bayer pattern arrays, each Bayer pattern array including a plurality of patterns arranged in an array;
wherein each pattern includes a pixel of a first color, a short exposure pixel of a second color and a long exposure pixel of the second color, and a pixel of a third color.

13. The image sensor of claim 12, wherein for each pattern, the pixel of the first color is a red (R) pixel, the short exposure pixel of the second color is a short exposure green (G_{S}) pixel, the long exposure pixel of the second color is a long exposure green (G_{L}) pixel, and the pixel of the third color is a blue (B) pixel.

14. The image sensor of claim 12, wherein the pixels in each pattern are arranged for Bayer pattern interpolation to generate color pixel information for each pixel in the pattern.

15. The image sensor of claim 12, wherein for each pattern, the pixel of the first color and the pixel of the third color have a same exposure as either the short exposure pixel or the long exposure pixel of the second color.

16. The image sensor of claim 12, wherein about half of the patterns in each Bayer pattern array have the pixel of the first color and the pixel of the third color with a same exposure as the short exposure pixel of the second color, and about half of the patterns in each array have the pixel of the first color and the pixel of the third color with the same exposure as the long exposure pixel of the second color.

17. The image sensor of claim 12, wherein each of the pixels in each Bayer pattern array are coupled for being combined with nearby pixels of a same color for enhancing the dynamic range.

18. The image sensor of claim 12, wherein each of the pixels in each Bayer pattern array are coupled for being averaged with nearby pixels of a same color for enhancing the dynamic range.

19. The image sensor of claim 12, wherein each of the pixels in each Bayer pattern array are coupled for being combined with nearby pixels of a same color using mixture control scaling factors for enhancing the dynamic range.

20. The image sensor of claim 12, wherein each of the pixels in each Bayer pattern array are coupled for being combined with nearby pixels of a same color using brightness control factors for enhancing scene brightness.

21. The image sensor of claim 12, the image sensor forming a part of an image capture device.

22. An image capture device for generating an enhanced dynamic range image, comprising:
an image sensor for generating a plurality of color pixel outputs as components of an image, the image sensor including a plurality of Bayer pattern arrays;
wherein each Bayer pattern array includes a plurality of patterns arranged in an array, each pattern including a pixel of a first color, a short exposure pixel of a second color and a long exposure pixel of the second color, and a pixel of a third color.

23. The image capture device of claim 22, wherein for each pattern, the pixel of the first color is a red (R) pixel, the short exposure pixel of the second color is a short exposure green (G_{S}) pixel, the long exposure pixel of the second color is a long exposure green (G_{L}) pixel, and the pixel of the third color is a blue (B) pixel.

24. The image capture device of claim 22, wherein for each pattern, the pixel of the first color and the pixel of the third color have a same exposure as either the short exposure pixel or the long exposure pixel of the second color.

25. The image capture device of claim 22, wherein about half of the patterns in each Bayer pattern array have the pixel of the first color and the pixel of the third color with a same exposure as the short exposure pixel of the second color, and about half of the patterns in each array have the pixel of the first color and the pixel of the third color with the same exposure as the long exposure pixel of the second color.

26. The image capture device of claim 22, further comprising an image processor coupled to the image sensor, the image processor programmed for performing Bayer pattern interpolation on each pattern to generate color pixel information for each pixel in the pattern.

27. The image capture device of claim 26, the image processor further programmed for combining each of the pixels in each Bayer pattern array with nearby pixels of a same color for enhancing the dynamic range.

28. The image capture device of claim 26, the image processor further programmed for averaging each of the pixels in each Bayer pattern array with nearby pixels of a same color for enhancing the dynamic range.

29. The image capture device of claim 26, the image processor further programmed for combining each of the pixels in each Bayer pattern array with nearby pixels of a same color using mixture control scaling factors for enhancing the dynamic range.

30. The image capture device of claim 26, the image processor further programmed for combining each of the pixels in each Bayer pattern array with nearby pixels of a same color using brightness control factors for enhancing scene brightness.

31. A method for generating color pixel output information as a component of an enhanced dynamic range image, comprising:
forming a Bayer pattern array from a plurality of patterns arranged in an array, each pattern including a pixel of a first color, a short exposure pixel of a second color and a long exposure pixel of the second color, and a pixel of a third color.

32. The method of claim 31, wherein the pixel of the first color is a red (R) pixel, the short exposure pixel of the second color is a short exposure green (G_{S}) pixel, the long exposure pixel of the second color is a long exposure green (G_{L}) pixel, and the pixel of the third color is a blue (B) pixel.

33. The method of claim 31, further comprising arranging the pixels in each pattern for Bayer pattern interpolation to generate color pixel information for each pixel in the pattern.

34. The method of claim 31, wherein for each pattern, the pixel of the first color and the pixel of the third color have a same exposure as either the short exposure pixel or the long exposure pixel of the second color.

35. The method of claim 31, wherein about half of the patterns in the array have the pixel of the first color and the pixel of the third color with a same exposure as the short exposure pixel of the second color, and about half of the patterns in the array have the pixel of the first color and the pixel of the third color with the same exposure as the long exposure pixel of the second color.

36. The method of claim 31, further comprising combining each of the pixels in the array with nearby pixels of a same color for enhancing the dynamic range.

37. The method of claim 31, further comprising averaging each of the pixels in the array with nearby pixels of a same color for the enhancing dynamic range.

38. The method of claim 31, further comprising combining each of the pixels in the array with nearby pixels of a same color using mixture control scaling factors for enhancing the dynamic range.

39. The method of claim 31, further comprising combining each of the pixels in the array with nearby pixels of a same color using brightness control factors for enhancing scene brightness.

40. The method of claim 31, further comprising performing Bayer pattern interpolation on each pattern to generate color pixel information for each pixel in the pattern.

41. The method of claim 31, further comprising combining each of the pixels in each Bayer pattern array with nearby pixels of a same color for enhancing the dynamic range.

42. The method of claim 31, further comprising averaging each of the pixels in each Bayer pattern array with nearby pixels of a same color for enhancing the dynamic range.

43. The method of claim 31, further comprising combining each of the pixels in each Bayer pattern array with nearby pixels of a same color using mixture control scaling factors for enhancing the dynamic range.

44. The method of claim 31, further comprising combining each of the pixels in each Bayer pattern array with nearby pixels of a same color using brightness control factors for enhancing scene brightness.
